(19) United States
(12) Patent Application Publication
(10) Pub. No.: US 2013/0196147 A1
(43) Pub. Date: Aug. 1, 2013

(54) EXTREMELY HIGH-TEMPERATURE RESISTANT PART HAVING AN EXTREMELY HIGH-TEMPERATURE RESISTANT COATING

(71) Applicants: Michael Dornbusch, Duesseldorf (DE); Hans Detlev Hinz, Schwerte (DE)

(72) Inventors: Michael Dornbusch, Duesseldorf (DE); Hans Detlev Hinz, Schwerte (DE)

(73) Assignee: EWALD DOERKEN AG, Herdecke (DE)

(21) Appl. No.: 13/821,613

(22) PCT Filed: Sep. 6, 2011
(86) PCT No.: PCT/EP2011/065376

§ 371 Date: Apr. 5, 2013

(30) Foreign Application Priority Data
Sep. 8, 2010 (DE) 10 2010 040 430.6

(51) Int. Cl. C09D 7/12

(52) U.S. Cl. CPC C09D 7/1208
USPC 428/336; 427/397.7; 427/387; 428/446; 428/447

(57) ABSTRACT

A part which is extremely high-temperature resistant and has an extremely high-temperature resistant coating having at least one silicate, the coating being stable at an operating temperature of more than 1,000° C. up to 2,000° C. For an extremely high-temperature resistant part having an extremely high-temperature resistant coating, which is stable at operating temperatures of over 1000° C. and can be applied simply and economically, it is provided that a coating means including a silicate or a mixture of silicates and water or solvent be used and be baked at temperatures of from 300° C. to 2000° C.

### BACKGROUND OF THE INVENTION

The invention relates to a part which is extremely high-temperature resistant and has an extremely high-temperature resistant coating, and the use of a coating means for producing an extremely high-temperature resistant coating, and a method for producing such an extremely high-strength coating.

Extremely high-temperature resistant parts which during use are exposed to temperatures of above 800° C., typically of above 1,000° C. up to 2,000° C., are often simultaneously exposed to an aggressive environment. Aggressive gases or deposits change the quality of the parts over time, particularly the surface properties thereof. This is the case for example for the linings of furnaces or combustion installations, for pipes or conveyors, for turbines and other thermally loaded parts which are permanently damaged as a consequence of contamination by foreign ions.

The properties of the surface of extremely high-temperature resistant substrates or parts are also impacted when under the influence of the environment ions are released from the surface during operation such that a large excess of these ions must be applied, in order to permanently make available a sufficient concentration of ions. Typical examples are catalysts which are used for example with exhaust gas purification.

Up to now, due to the high operating temperatures of more than 1,000° C. to 2,000° C., generally a coating made of alloys or ceramic coatings is applied on the extremely high-temperature resistant parts, in order to protect the surface from changes. Typical examples are given in U.S. Pat. No. 6,221,181 (ABB Research Ltd.) and US 2008/0 261 069 (Hitachi Ltd.). These coatings are expensive, must be matched to the part and due to the thickness of the coating are not suited to all applications.

There are also individual descriptions, for example in US 2004/0 180 223 (Tokyo Ohka Ko-byo Co.), of coatings having siloxanes with organic portions that are baked at temperatures of up to 750° C. The coated parts themselves are however not intended for use at high temperatures above 800° C. High temperatures are attained however only for the coating process. It is pointed out here that such coatings having organic portions can only be produced under an inert atmosphere because otherwise a sufficient coating thickness cannot be created due to the degradation of the organosilane portion.

DE 10 2007 010 955 A1 discloses a coating composition with which the corrosion resistant coatings can be obtained with temperature stability up to 1,000° C., particularly at least up to 800° C. At least a silicate, a component with anti-adhesive properties (selected from the group of graphite, graphite compounds and metal sulfides) and at least one metal carbide are named as main components of the coating composition. Here, the range of the operating temperature is extended to 1,000° C. It is obvious from the document that the coating proposed therein is not suited for operating temperatures above 1,000° C.

It is the object of the invention to propose an extremely high-temperature resistant coating for an extremely high-temperature resistant part that is stable at operating temperatures of above 1,000° C. up to 2,000° C., and which is simple and economical to apply.

### SUMMARY OF THE INVENTION

According to the invention a high-temperature resistant part, particularly an extremely high-temperature resistant part that is stable at an operating temperature of above 1,000° C. up to 2,000° C. is proposed having an extremely high-temperature resistant coating which has a siliceous network. Siliceous or SiO2 networks are generally known. Coating means based on silicates or respectively polysilicates are known. Sodium silicate as a typical raw material for these coating means is cost-effective and permits processing into a coating of numerous parts. Already in this simple design, extremely high-temperature coatings can be attained which are simple to produce.

It is considered an advantage of the coating according to the invention that most varied extremely high-temperature resistant parts such as graphite, metals or respectively alloys, but also ceramic and mineral materials can be overlaid with the coating, which forms a siliceous network. The coating according to the invention does not corrode the parts, and is itself inert with respect to aggressive environments, for example with respect to acidic, alkaline or corrosive surroundings, even at the named high temperatures.

The coating, thus the film, which arises after hardening of the coating means applied in liquid form, is very thin. The coating typically has a layer thickness or dry film thickness of 1 μm to 20 μm, preferably a layer thickness of 3 μm to 10 μm. If the application method is controlled particularly precisely, thinner layer thicknesses are possible. If more material is used, greater layer thicknesses are possible. The greater material usage is however increasingly uneconomical and the formation of the film does not improve with strongly increasing layer thicknesses. The film forms cracks, among others things, or hardens non-uniformly.

### DETAILED DESCRIPTION

According to an advantageous embodiment of the invention, the coating is stable up to 2,000° C., that is, the coating not only withstands hardening at this temperature, but also the part upon which the coating is applied can be used at operating temperatures of more than 1,000° C. up to 2,000° C. Numerous industrial production methods presume operating temperatures of above 1,000° C. to 1,500° C., for example sintering of materials or respectively workpieces often occurs at these temperatures. Also, the drying or hardening of workpieces, or the incineration of organic residues in power plant furnaces can occur at temperatures for instance of 1,100° C. to 1,300° C. Using the coating according to the invention, the service life of extremely high-temperature resistant parts, such as supporting plates for example upon which such materials or workpieces are disposed in furnaces or are transported through continuous furnaces, can be extended, and likewise the service life of parts which are used in combustion furnaces or turbine plants. The service life of catalysts can also be extended by the application of the coating means according to the invention.

According to an advantageous further development of the invention, the coating has portions of a SiO4 network. A SiO4 network arises when silane is hardened into a polysiloxane. Silanes have organic residues that generally are not stable at temperatures of above 500° C. unless special protective measures are taken such as hardening under an inert-gas atmosphere.

Although silanes, which after the condensation reaction to siloxanes form a SiO4 network, would seem unsuitable to form an extremely high-temperature resistant coating, they have proven to be helpful for the present coating because they allow production of a thin and yet uniform coating. Silanes having good film forming properties facilitate, after application and before hardening, the above-mentioned particularly thin and yet uniformly thick coating, even if they degrade during hardening.

Along with monomer silanes, prehydrolyzed oligomers or polymers, thus siloxanes, can be used. A prerequisite is merely that the silanes can be applied still in liquid form, or respectively soluble in water or possibly solvent, and can form film on the part, that is, they are not yet hardened. Siliceous network and SiO4 network can according to the invention be formed together, forming a sealed film, on the extremely high-temperature resistant part, in that silicates and silanes, or respectively siloxanes, are hardened even if silanes, or respectively siloxanes, are degraded or decomposed at least to some extent during the hardening.

According to the invention, two components which are known per se, are combined into a coating means and are used for producing an extremely high-temperature resistant coating on a high-strength part. The two components are: 1st component: a silicate, preferably a polysilicate, 2nd component: water or solvent.

The extremely high-temperature resistant coating, which can be produced using this coating means, resists high temperatures to which the part is exposed during operation. The coating means according to the invention is generally stable at operating temperatures of up to 2,000° C. for the coated workpiece. Thus use in combustion furnaces or hardening systems for example which are operated at operating temperatures of above 1,000° C. to 1,500° C., is easily possible.

Furnaces or other systems which are operated at such high temperatures are operated as continuously as possible due to energy and economic concerns. The coating according to the invention significantly extends the service life of parts of such furnaces and systems without itself being expensive or complex. This fact is also based on the recognition that even the simple coating using a siliceous network or a network containing silicate and silanes, or respectively siloxane, in short, a SiO2/SiO4 network, has significant advantages because already the protection from the surrounding atmosphere or the protection against foreign substances which impact the furnaces or systems, is sufficient. For numerous parts a special protection against mechanical damage or against corrosion is unnecessary, the application of a coating means according to the invention already results in a significant extension of the service life of the part. The resulting economic advantage is obvious.

Silicates that are suitable for the production of the coating according to the invention are all water-soluble silicates or respectively silicate compounds. Sodium silicates, thus lithium polysilicates, sodium polysilicates and potassium polysilicates, or the mixtures thereof, colloidal silicic acids, silica sol, magnesium silicates, calcium silicates and aluminum silicates or the mixtures thereof are particularly suitable, as long as they are water soluble.

However, if particularly thin uniform coatings are to be produced, then it is advantageous to add a third component to the coating means. A silane or siloxane is chosen expediently as the third component. The silicatic component and the silane or siloxane can be easily processed mixed together.

The silanes used preferably have the epoxy groups, thiol groups, or hydroxyalkyl groups. However, alkyl silanes, particularly alkenyl silanes and methacrylate silanes are suitable for producing the coating means according to the invention. Oligomer or polymer compounds, the siloxanes, produced from the cited silanes, are also suitable for producing the bonding agent according to the invention. Trialkoxysilanes are particularly suitable due to the good film forming properties thereof for producing the extremely high-temperature resistant coating means. Typical silanes are γ-Glycidyloxypropyl-triethoxysilane or γ-Glycidyloxypropyltrimethoxysilane or mixtures of silanes. For producing a coating means that releases few volatile organic components during hardening, the above named silanes can be prehydrolyzed at the factory at least to some extent into siloxanes for producing the coating means. A prerequisite for the suitability of siloxanes for use in the coating means used according to the invention is that the prehydrolyzed siloxanes can still form films and are present in a liquid form, or respectively in solution.

For the coating means according to the invention, the weight proportion of the silicate component is generally greater than the weight proportion of the silane/siloxane component. The ratios of silicate: silane or respectively siloxane is preferably present in a range of 10:1 to 1.5:1, typical ratios of silicate to silane are 5:1 to 3:1.

The weight proportion of water or solvent is generally over 50% of the total weight proportions of the coating means. The proportion is up to 90%, typically 55% to 80%. Water is preferred in order to make the coating means sufficiently fluid such that the coating means quickly forms a uniform and thin coating on the part. Solvents are also suitable but are often not used due to difficulty handling them with the release of organic components. Additionally, mixtures of water and solvents can be used.

The coating means can contain additives, for example stabilizers, defoamers and the like.

The invention further relates to a method for producing an extremely high-temperature resistant coating on an extremely high-temperature resistant part having the steps:

applying the liquid coating onto the part, baking the coating at temperatures of 300° C. to 2,000° C.

The baking can take place as a separate process. Alternatively, the baking, particularly with parts which are used as carriers or conveying means in drying ovens, sintering furnaces or kilns, can take place in the respective furnace in an “idle pass”, as long as the dwell time in the furnace is sufficient in order to allow the coating to harden.

Details of the invention are described in more detail based on an example:

For producing a coating means with which the extremely high-temperature resistant coating according to the invention is produced on an extremely high-temperature resistant part,

10 parts γ-glycidyloxypropyltriethoxysilan (solids content: 50%)
30 parts lithium polysilicate (solids content: 50%)
60 parts water, demineralized
are mixed by stirring. According to a first alternative, the liquid coating means is applied on a graphite plate and dried at 1,100° C. and hardened into a 10 μm thick film.

The graphite plate is used as a carrying plate for sintering blanks which are sintered in a sintering furnace at 1,100° C. The carrying plate coated with the coating means according to the invention is placed in the sintering furnace without carrying sintering blanks, however. After one sintering cycle, the coating is hardened and then the carrying plate can be used for the actual function thereof. It is obvious that this form of coating of parts is particularly simple and economical.

The extremely high-temperature resistant coating according to the invention has the effect that residues that fall onto the carrying plate during the sintering of the blanks, or respectively workpieces, are not transferred onto other blanks or workpieces during the next sintering process. The high-temperature resistant coating captures these residues without subsequently releasing them again.

According to a second alternative, the coating means described above is applied on fixtures made of an extremely high-temperature resistant ferrous alloy and is hardened within 30 minutes, wherein the temperature during the hardening is 300° C. The parts are then mounted as fixtures in a combustion furnace for organic residues in which the operating temperature is between 1,050° C. and 1,300° C. The ferrous alloy remains temperature stable for a longer time because the ferrous alloy is protected by the coating according to the invention against changes on the surface that up to now led to softening of the special steel.

1. A part that is extremely high-temperature resistant and that during use is exposed to temperatures of up to 2,000° C., having an extremely high-temperature resistant coating having at least one silicate, the coating being stable at an operating temperature of above 1,000 ° C. and up to 2,000° C.

2. The part according to claim 1, wherein the coating is stable at an operating temperature of 1,100° C. to 2,000° C.

3. The part according to claim 1, wherein the coating has a layer thickness of 1 μm to 20 μm.

4. The part according to claim 1, wherein the coating has silanes or siloxanes.

5. A method of providing a stable coating on a part, comprising applying a coating means having a silicate or a mixture of silicates as a first component and water or solvent as a second component to the part to produce a coating stable at operating temperatures of more than 1,000° C. to 2,000° C. on an extremely high-temperature resistant part.

6. The method according to claim 5, wherein the coating is stable at an operating temperature of 1,100° C. to 2,000° C. on an extremely high-temperature resistant part.

7. The method of a coating means according to claim 5, further comprising a silane or a siloxane or a mixture thereof as a third component of the coating means.

8. The method according to claim 5, wherein water soluble silicates, particularly lithium polysilicates, sodium polysilicates and potassium polysilicates, or mixtures thereof, colloidal silicic acids, magnesium silicates, calcium silicates and aluminum silicates or mixtures thereof comprise the a first component of the coating means.

9. The method according to claim 7, wherein silanes that have epoxy groups, thiol groups, or hydroxyalkyl groups;
alkylsilanes, particularly alkenyl silanes and methacrylate silanes, oligomers or polymers of siloxane or mixtures of these compounds are used for producing a bonding means.

10. The method of claim 5, wherein:
applying the coating means as a liquid coating on the part, and
baking the coating at temperatures of 300° C. to 2,000° C.

11. The part according to claim 3, wherein the layer thickness is between 3 μm and 10 μm.

12. The part according to claim 2, wherein the coating is stable at an operating temperature of 1,300° C. to 1,500° C.
